(19) United States
(12) Patent Application Publication
(10) Pub. No.: US 2024/0255044 A1
(43) Pub. Date: Aug. 1, 2024

(54) BALL SCREW APPARATUS

(71) Applicant: Wei-Ting Lin, Taichung City (TW)

(72) Inventor: Wei-Ting Lin, Taichung City (TW)

(73) Assignee: Wei-Ting Lin, Taichung City (TW)

(21) Appl. No.: 18/102,028

(22) Filed: Jan. 26, 2023

(51) Int. Cl. F16H 25/22

(52) U.S. Cl. CPC F16H 25/2214

(57) ABSTRACT

A ball screw apparatus may include a screw rod, a nut, two circulators, a plurality of rolling balls, and a return tube. The screw rod has a spiral groove formed thereon, and the two circulators are respectively connected to two ends of the nut. The nut comprises a through hole axially penetrating therethrough, and a first rolling groove is formed on the inner wall of the through hole, and an outer side of the through hole has a return channel penetrating from one end of the nut to the other. Each of the circulators comprises a second rolling groove, and the second rolling grooves are adapted to connect to the first rolling groove and the return channel, so that the rolling balls installed between the spiral groove and the first rolling groove are adapted to smoothly circulate on the ball screw apparatus.

### FIELD OF THE INVENTION

The present invention relates to a ball screw apparatus and more particularly to a long service life ball screw apparatus without operating noise.

### BACKGROUND OF THE INVENTION

Referring to FIG. 7, the conventional ball screw apparatus (60) comprises a screw rod (61), a nut (62), two circulators (63), and a plurality of rolling balls (64). The rod body of the screw rod (61) has a spiral groove (611), and two circulators (63) are respectively connected to two ends of the nut (62), and a spiral first rolling groove (621) is formed in the inner wall of a penetrating channel on the nut (62). The outer side of the penetrating channel comprises a return channel (622) penetrating through two ends of the nut (62). Each of the circulators (63) has a second rolling groove (631) connecting to the first rolling groove (621) and the return channel (622), so that the rolling balls (64) installed between the spiral groove (611) and the first rolling groove (621) is adapted to smoothly circulate on the ball screw apparatus (60).

However, the conventional ball screw apparatus has following disadvantages: when the ball screw apparatus (60) is working, the rolling balls (64) can only push forward one by one in the running direction, and cannot be turned sideways by the return channel (622) during non-load process of reflow, so that the rolling balls (64) are gradually worn into an elliptical shape due to single point of loading (as shown in FIG. 8), thereby effecting the stability of its operation, greatly shortening its service life, and making disturbing noises. Therefore, there remains a need for a new and improved design for a ball screw apparatus to overcome the problems presented above.

### SUMMARY OF THE INVENTION

The present invention provides a ball screw apparatus comprising a screw rod, a nut, two circulators, a plurality of rolling balls, and a return tube. The screw rod has a spiral groove formed thereon, and the two circulators are respectively connected to two ends of the nut. The nut comprises a through hole axially penetrating therethrough, and a first rolling groove is formed on the inner wall of the through hole, and an outer side of the through hole has a return channel penetrating from one end of the nut to the other. Each of the circulators comprises a second rolling groove, and the second rolling grooves are adapted to connect to the first rolling groove and the return channel, so that the rolling balls installed between the spiral groove and the first rolling groove are adapted to smoothly circulate on the ball screw apparatus. A plurality of spiral threads are formed on the inner tube of the return tube, and the number of the spiral threads is set as an odd number that is not divisible. When the return tube is installed in the return channel, the rolling balls circulating through the return channel is configured to be driven by the spiral threads to have a specific angle of lateral flip as the rolling balls pass through the return tube.

Comparing with conventional ball screw apparatus, the present invention is advantageous because: (i) when non-loaded, the rolling balls circulating through the return channel is configured to be driven by the spiral threads to have a specific angle of lateral flip as the rolling balls pass through the return tube, such that when the rolling balls are circulated and loaded between the spiral groove and the first rolling groove, the rolling balls no longer are constantly stressed at the same single point, thereby preventing the rolling balls from deformation, prolonging the service life of the ball screw apparatus, and preventing the ball screw apparatus from generating noise during operation; and (ii) the spiral threads is designed with the odd number that can prevent the rolling balls from turning sideways and then returning to the original position, or prevent the rolling balls from repeatedly stressed on specific points such as top and bottom points or top, bottom, left, and right points.

### BRIEF DESCRIPTION OF THE DRAWINGS

FIG. 1 is a three-dimensional assembly view of a ball screw apparatus of the present invention.

FIG. 2 is a three-dimensional exploded view of the ball screw apparatus of the present invention.

FIG. 3 is a sectional view of a return tube of the ball screw apparatus of the present invention when in use.

FIG. 4 is a schematic view illustrating the ball screw apparatus of the present invention is in use.

FIG. 5 is a schematic view illustrating a plurality of rolling balls circulate on a screw rod of the ball screw apparatus of the present invention.

FIG. 6 is a schematic view illustrating the rolling balls (only showing one rolling ball) have lateral flip when passing through a plurality of spiral threads on the return tube.

FIG. 7 is a prior art.

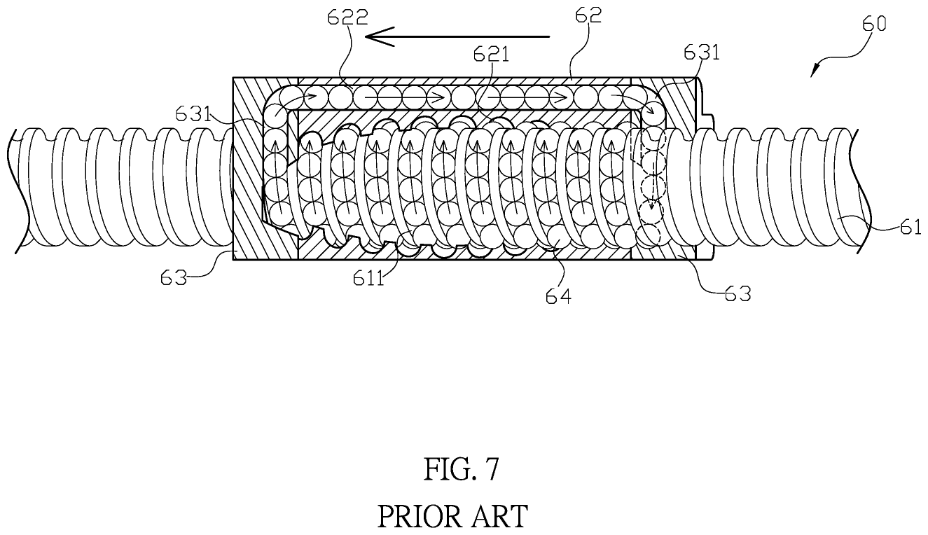

FIG. 8 is a prior art.

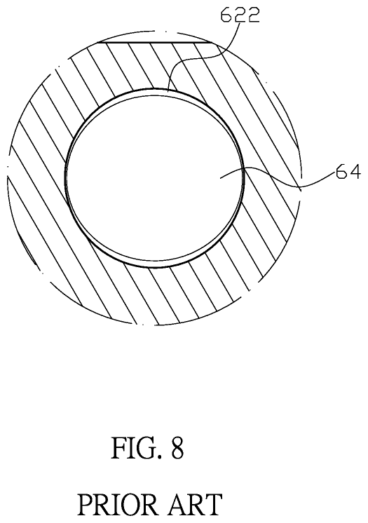

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

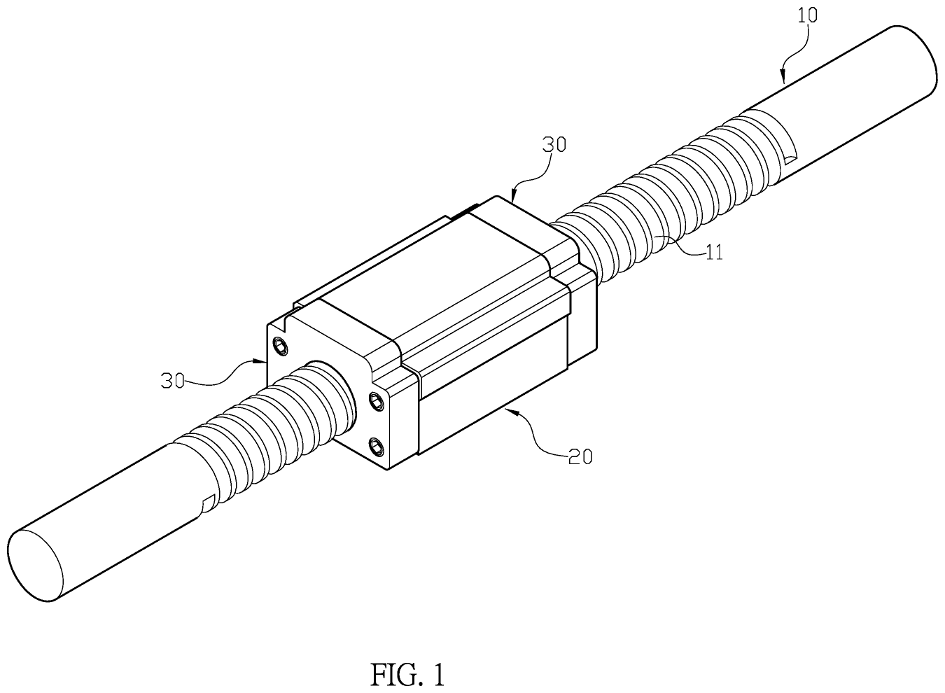

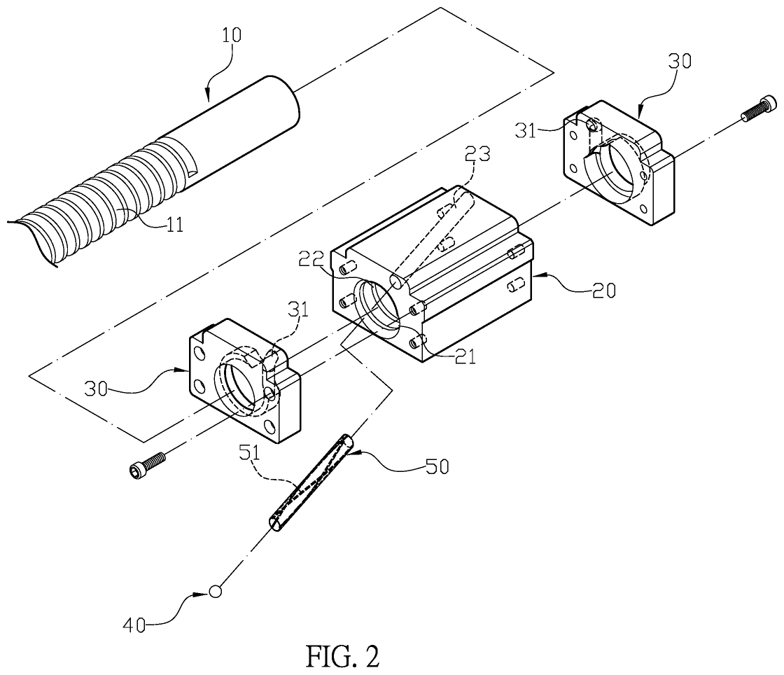

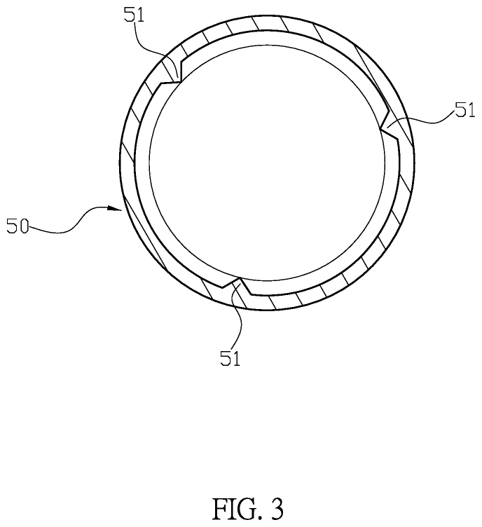

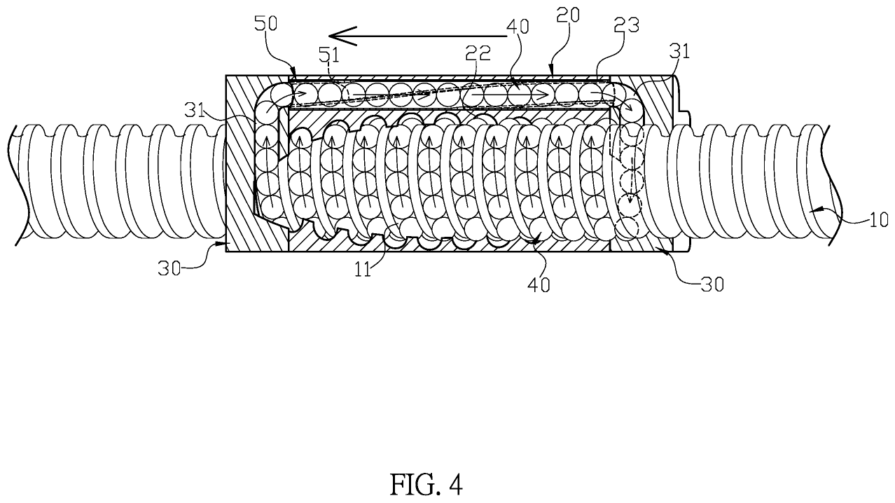

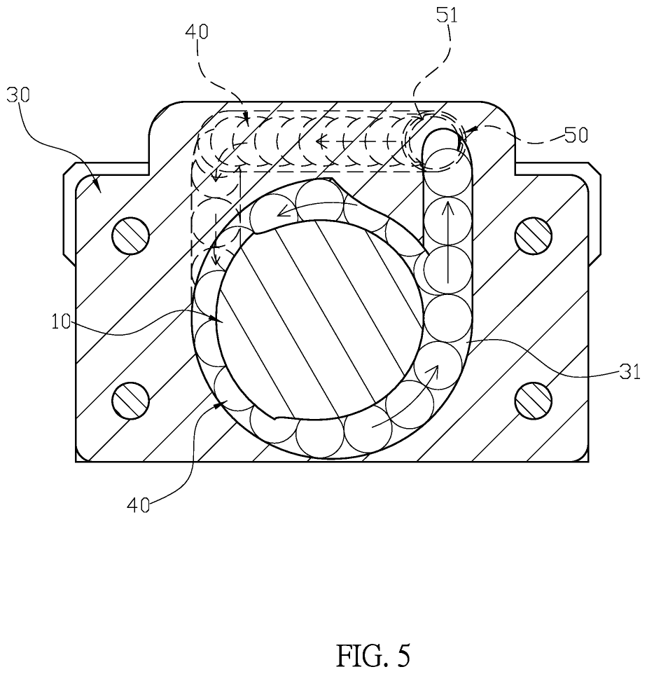

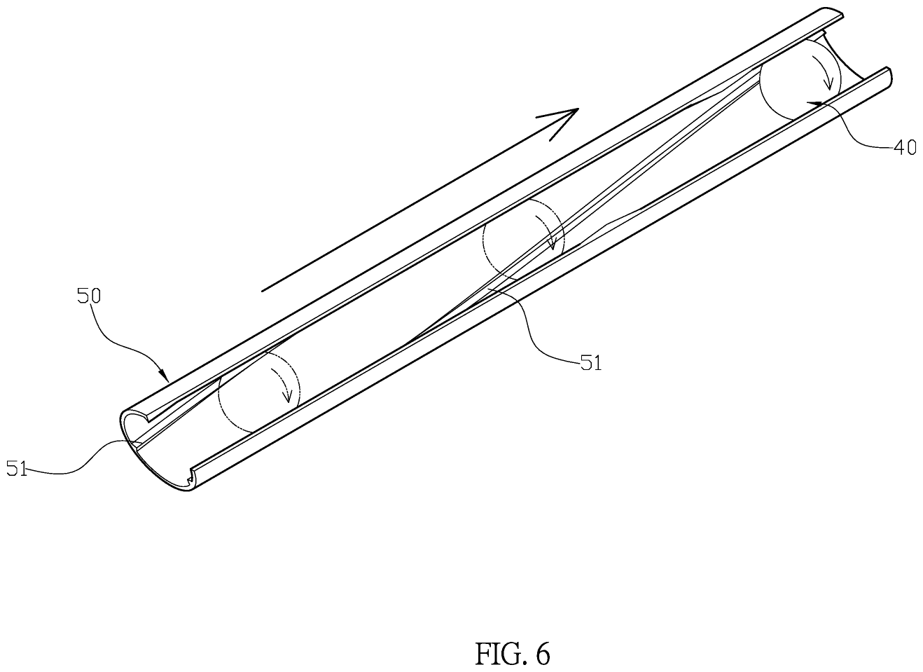

Referring to FIGS. 1 to 5, the present invention provides a ball screw apparatus comprising a screw rod (10), a nut (20), two circulators (30), a plurality of rolling balls (40), and a return tube (50). The screw rod (10) has a spiral groove (11) formed thereon, and the two circulators (30) are respectively connected to two ends of the nut (20). The nut (20) comprises a through hole (21) axially penetrating therethrough, and a first rolling groove (22) is formed on the inner wall of the through hole (21), and an outer side of the through hole (21) has a return channel (23) penetrating from one end of the nut (20) to the other. Each of the circulators (30) comprises a second rolling groove (31), and the second rolling grooves (31) are adapted to connect to the first rolling groove (22) and the return channel (23), so that the rolling balls (40) installed between the spiral groove (11) and the first rolling groove (22) are adapted to smoothly circulate on the ball screw apparatus. Moreover, a plurality of spiral threads (51) are formed on the inner tube of the return tube (50), and the number of the spiral threads (51) is set as an odd number that is not divisible. When the return tube (50) is installed in the return channel (23), the rolling balls (40) circulating through the return channel (23) is configured to be driven by the spiral threads (51) to have a specific angle of lateral flip as the rolling balls (40) pass through the return tube (50) (as shown in FIG. 6).

In one embodiment, the return tube (50) is a wear-resistant plastic tube.

In another embodiment, the return tube (50) comprises three spiral threads (51) formed on the inner tube of the return tube (50).

In still another embodiment, the return tube (50) comprises five spiral threads (51) formed on the inner tube of the return tube (50).

In a further embodiment, the return tube (50) comprises seven spiral threads (51) formed on the inner tube of the return tube (50).

Comparing with conventional ball screw apparatus, the present invention is advantageous because: (i) when non-loaded, the rolling balls (40) circulating through the return channel (23) is configured to be driven by the spiral threads (51) to have a specific angle of lateral flip as the rolling balls (40) pass through the return tube (as shown in FIG. 6), such that when the rolling balls (40) are circulated and loaded between the spiral groove (11) and the first rolling groove (22), the rolling balls (40) no longer are constantly stressed at the same single point, thereby preventing the rolling balls (40) from deformation, prolonging the service life of the ball screw apparatus, and preventing the ball screw apparatus from generating noise during operation; and (ii) the spiral threads (51) is designed with the odd number that can prevent the rolling balls (40) from turning sideways and then returning to the original position, or prevent the rolling balls (40) from repeatedly stressed on specific points such as top and bottom points or top, bottom, left, and right points.

Having described the invention by the description and illustrations above, it should be understood that these are exemplary of the invention and are not to be considered as limiting. Accordingly, the invention is not to be considered as limited by the foregoing description, but includes any equivalents.

1. A ball screw apparatus comprising a screw rod, a nut, two circulators, a plurality of rolling balls, and a return tube;
wherein the screw rod has a spiral groove formed thereon;
wherein the two circulators are respectively connected to two ends of the nut; the nut comprises a through hole axially penetrating therethrough, and a first rolling groove is formed on the inner wall of the through hole, and an outer side of the through hole has a return channel penetrating from one end of the nut to the other; each of the circulators comprises a second rolling groove, and the second rolling grooves are adapted to connect to the first rolling groove and the return channel, so that the rolling balls installed between the spiral groove and the first rolling groove are adapted to smoothly circulate on the ball screw apparatus;
wherein a plurality of spiral threads are formed on the inner tube of the return tube, and the number of the spiral threads is set as an odd number; when the return tube is installed in the return channel, the rolling balls circulating through the return channel is configured to be driven by the spiral threads to have lateral flip as the rolling balls pass through the return tube,
wherein the return tube comprises three spiral threads formed on the inner tube of the return tube.

2. The ball screw apparatus of claim 1, wherein the return tube is a wear-resistant plastic tube.

3. (canceled)

4. (canceled)

5. (canceled)
